(19) United States
(12) Patent Application Publication
(10) Pub. No.: US 2010/0257299 A1
(43) Pub. Date: Oct. 7, 2010

(54) TRANSMISSION WIRE WITH SWITCHING APPARATUS AND SWITCHING METHOD THEREOF

(75) Inventor: Ying-Chuan Tsai, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/485,920

(22) Filed: Jun. 17, 2009

(30) Foreign Application Priority Data
Apr. 2, 2009 (CN) 200910301320.X

(51) Int. Cl. G06F 13/14

(52) U.S. Cl. 710/305

(57) ABSTRACT

A transmission wire includes a first interface, a second interface, and a microprocessor. The first interface includes a first pin, a second pin, and a first ground pin. The second interface includes a third pin, a fourth pin, and a second ground pin. The second ground pin is connected to the first ground pin. The microprocessor includes four pins connected to the first, second, third, and the fourth pins correspondingly. The microprocessor reads data from the first and second interfaces, to transmit data from the first pin to the third pin or the fourth pin, and transmit data from the third pin or the fourth pin to the second pin correspondingly.

### BACKGROUND

1. Technical Field

The present disclosure relates to transmission wires and switching methods thereof and, particularly, to a transmission wire with a switching apparatus and a switching method for the transmission wire.

2. Description of Related Art

Transmission wires are used for transmitting data between two devices, such as a computer system and a peripheral apparatus, or two computer systems. Because the two connected devices may operate in different duplex modes, the transmission wires are typically arranged according to one or both of two transmission modes, i.e. crossover transmission mode or straight through transmission mode. Generally, the crossover transmission wire must be used between the two computer systems for transmitting data, and the straight through transmission wire must be used between the computer system and a modem, which is connected to Ethernet networks.

Referring to FIGS. 3 and 4, each of the crossover transmission wire 8 and the straight through transmission wire 9 includes two interfaces 80 and 90. The interface 80 includes a pin TX8, a pin RX8, and a ground pin GND8. The interface 90 includes a pin TX9, a pin RX9, and a ground pin GND9. For the first transmission wire 8, the pin TX8 is connected to the pin RX9, the pin RX8 is connected to the pin TX9, and the ground pin GND8 is connected to the ground pin GND9. For the second transmission wire 9, the pin TX8 is connected to the pin TX9, the pin RX8 is connected to the pin RX9, and the ground pin GND8 is connected to the ground pin GND9.

As described above, users need select the crossover or the straight through transmission wire according to the duplex modes of the two devices, to avoid duplex mismatching, which is inconvenient.

### BRIEF DESCRIPTION OF THE DRAWINGS

FIG. 1 is a schematic block diagram of an exemplary embodiment of a transmission wire.

FIG. 2 is a flowchart of an exemplary embodiment of a switching method for the transmission wire of FIG. 1.

FIG. 3 is a schematic block diagram of a conventional crossed transmission wire.

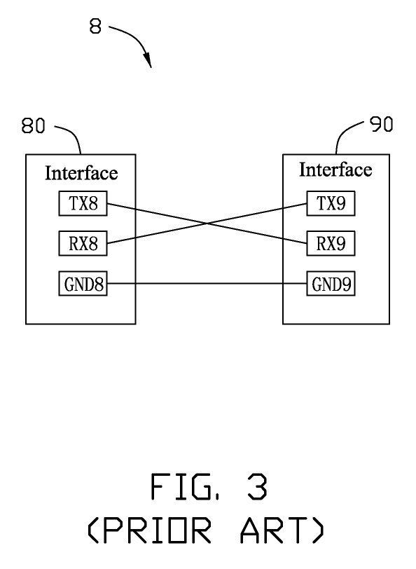

FIG. 4 is a schematic block diagram of a conventional straight through transmission wire.

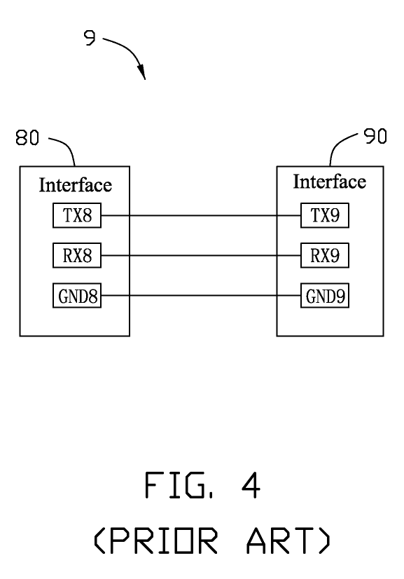

### DETAILED DESCRIPTION

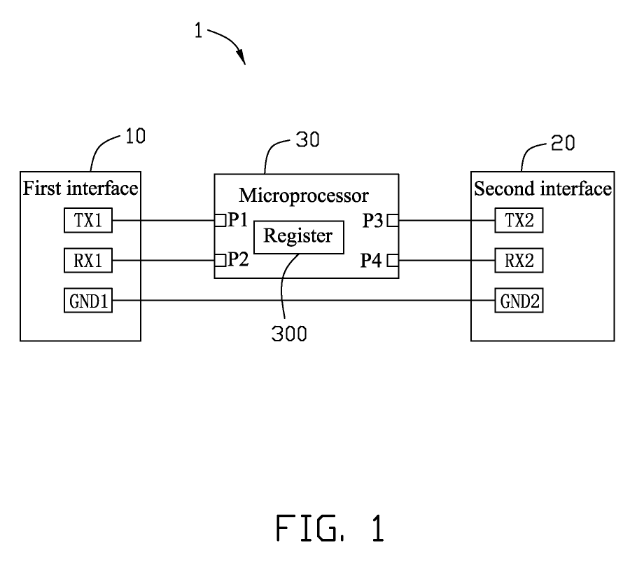

Referring to FIG. 1, an exemplary embodiment of a transmission wire 1 includes a first interface 10, a second interface 20, and a microprocessor 30.

The first interface 10 includes a first pin TX1, a second pin RX1, and a first ground pin GND1. The second interface 20 includes a third pin TX2, a fourth pin RX2, and a second ground pin GND2. The microprocessor 30 includes four pins P1, P2, P3, P4, and a register 300.

The first pin TX1, the second pin RX1, the third pin TX2, and the fourth pin RX2 are connected to the four pins P1, P2, P3, and P4, respectively. The first ground pin GND1 is connected to the second ground pin GND2.

In the embodiment, the transmission wire 1 is to transmit data between two computer systems or between a computer system and a peripheral apparatus, such as a Universal Serial Bus (USB) device using one of two transmission modes, crossover transmission mode or straight through transmission mode. The first interface 10 is to connect to the computer system. The second interface 20 is to connect to the other computer system or the peripheral apparatus.

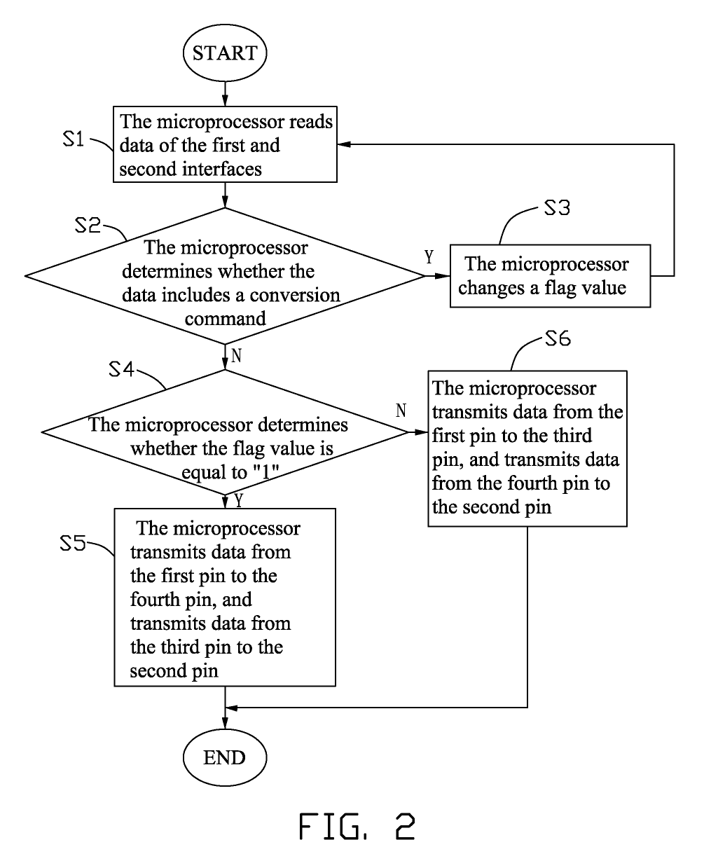

Referring to FIG. 2, an exemplary embodiment of a switching method for the transmission wire 1 includes the following steps.

In step S1, the microprocessor 30 reads data from the first interface 10 and the second interface 20.

In step S2, the microprocessor 30 determines whether the data includes a conversion command or not, if yes, the flow goes to step S3, if not, the flow goes to step S4. In the embodiment, it can be understood that upon the condition that the duplex modes of the two devices are in accordance with the transmission mode, such as if the two device are two computer systems, and the transmission wire 1 works in the crossover transmission mode, the duplex modes of the two devices are in accordance with the transmission mode, and the data includes no conversion command. Otherwise, upon the condition that the duplex modes of the two devices are not in accordance with the transmission mode, such as if the two devices are two computer systems, and the transmission wire 1 works in the straight through transmission mode, the duplex modes of the two devices are not in accordance with the transmission mode, and the data includes a conversion command.

In step S3, the microprocessor 30 changes a flag value of the microprocessor 30. It can be understood that the flag value of the microprocessor 30 denotes the transmission mode of the transmission wire 1. Because the duplex modes of the two devices are not in accordance with the transmission mode in step S2, the microprocessor 30 changes the flag value for changing the transmission mode of the transmission wire 1. The flow goes to step S1.

In step S4, the microprocessor 30 determines whether a flag value of the microprocessor 30 is equal to “1”, if yes, the flow goes to step S5, if not, the flow goes to step S6.

In step S5, the microprocessor 30 transmits data from the first pin TX1 to the fourth pin RX2, and transmits data from the third pin TX2 to the second pin RX1, namely the transmission mode of the transmission wire 1 is the crossover transmission mode.

In step S6, the microprocessor 30 transmits data from the first pin TX1 to the third pin TX2, and transmits data from the fourth pin RX2 to the second pin RX1, namely the transmission mode of the transmission wire 1 is the straight through transmission mode.

It can be understood that the microprocessor 30 stores data from the first interface 10 and the second interface 20 in the register 300, and transmits data to the pins P1-P4 correspondingly from the register 300.

The foregoing description of the exemplary embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A transmission wire comprising:
a first interface comprising a first pin, a second pin, and a first ground pin;
a second interface comprising a third pin, a fourth pin, and a second ground pin connected to the first ground pin; and
a microprocessor comprising four pins connected to the first, second, third, and fourth pins correspondingly, wherein the microprocessor is operable to read data from the first and second interfaces, to transmit data from the first pin to the third pin or the fourth pin, and transmit data from the third pin or the fourth pin to the second pin correspondingly.

2. The transmission wire of claim 1, wherein the microprocessor further comprises a register, the microprocessor stores the data from the first and the second interfaces in the register, and transmits data to the first, second, third, and fourth pins correspondingly from the register.

3. A switching method of a transmission wire, the transmission wire comprising:
a first interface comprising a first pin, a second pin, and a first ground pin;
a second interface comprising a third pin, a fourth pin, and a second ground pin connected to the first ground pin; and
a microprocessor comprising four pins connected to the first, second third, and fourth pins correspondingly;
the switching method comprising:
reading data of the first and the second interfaces by the microprocessor;
determining whether the data comprises a conversion command or not; and
transmitting data using the microprocessor from the first pin to the third pin or the fourth pin, and transmitting data from the third pin or the fourth pin to the second pin according to a flag value.

4. The switching method of claim 3, wherein the step of transmitting data comprises:
the microprocessor determining whether the flag value is equal to “1” or not;
the microprocessor transmitting data from the first pin to the fourth pin, and transmitting data from the third pin to the second pin, in response to the flag value equal to “1”; and
the microprocessor transmitting data from the first pin to the third pin, and transmitting data from the fourth pin to the second pin, in response to the flag value unequal to “1”.

5. The switching method of claim 3, further comprising:
changing a flag value of the microprocessor in response to the data not comprising the conversion command.
